(19) United States
(12) Patent Application Publication
(10) Pub. No.: US 2025/0192284 A1
(43) Pub. Date: Jun. 12, 2025

(54) COMPRESSIBLE THERMAL BARRIER ASSEMBLIES FOR USE WITHIN TRACTION BATTERY PACKS

(71) Applicant: FORD GLOBAL TECHNOLOGIES, LLC, Dearborn, MI (US)

(72) Inventor: Patrick Daniel Maguire, Ann Arbor, MI (US)

(21) Appl. No.: 18/950,335

(22) Filed: Nov. 18, 2024

Related U.S. Application Data
(60) Provisional application No. 63/607,888, filed on Dec. 8, 2023.

(51) Int. Cl. H01M 10/658; B60L 50/64; F16L 59/02; H01M 10/625

(52) U.S. Cl. CPC H01M 10/658; B60L 50/64; F16L 59/02; H01M 10/625; H01M 2220/20

(57) ABSTRACT

Thermal barrier assemblies are provided for inhibiting the transfer of thermal energy inside a traction battery pack while simultaneously accommodating battery cell swelling forces and providing sufficient structural stiffness. An exemplary thermal barrier assembly may include a structural barrier, a thermal insulation medium, and one or more flexible structures that are arranged to contain the thermal insulation medium within an outer perimeter provided by the structural barrier. The flexible structures may be configured as flexible links or film layers that are capable of mechanically isolating a first portion of the structural barrier that contacts a battery cell undergoing swelling from a second portion of the structural barrier that is not in contact with the battery cell, thereby providing uniform resistance to the battery cell swelling forces while also providing structural stiffness.

### CROSS-REFERENCE TO RELATED APPLICATIONS

This disclosure claims priority to U.S. Provisional Application No. 63/607,888, which was filed on Dec. 8, 2023 and is incorporated herein by reference in its entirety.

### TECHNICAL FIELD

This disclosure relates generally to traction battery packs, and more particularly to thermal barrier assemblies arranged for mitigating the transfer of thermal energy within traction battery packs while also providing structural stiffness and accommodating battery cell swelling forces.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a thermal barrier assembly arranged to partition a battery cell stack into a first compartment and a second compartment. The thermal barrier assembly includes a structural barrier, a thermal insulation medium, and a flexible structure that contains the thermal insulation medium within an interior space of the structural barrier.

In a further non-limiting embodiment of the foregoing traction battery pack, the flexible structure includes a first flexible link that secures a first outer rib of the structural barrier to a first portion of the structural barrier, and a second flexible link that secures the first outer rib to a second portion of the structural barrier.

In a further non-limiting embodiment of either of the foregoing traction battery packs, the first portion is an upper plateau of the structural barrier, and the second portion is a lower plateau of the structural barrier.

In a further non-limiting embodiment of any of the foregoing traction battery packs, the upper plateau interfaces with an upper enclosure structure of the traction battery pack, and the lower plateau interfaces with a lower enclosure structure of the traction battery pack.

In a further non-limiting embodiment of any of the foregoing traction battery packs, the first portion and the second portion are each part of a second outer rib of the structural barrier.

In a further non-limiting embodiment of any of the foregoing traction battery packs, the first flexible link and the second flexible link each include a sinusoidal shaped cross-sectional profile or an arc shaped cross-sectional profile.

In a further non-limiting embodiment of any of the foregoing traction battery packs, the flexible structure includes a third flexible link that secures a second outer rib of the structural barrier to the first portion of the structural barrier, and a fourth flexible link that secures the second outer rib to the second portion of the structural barrier.

In a further non-limiting embodiment of any of the foregoing traction battery packs, the second outer rib includes a first thickness that is greater than a second thickness of the first outer rib.

In a further non-limiting embodiment of any of the foregoing traction battery packs, the structural barrier includes an inner rib arranged between the first outer rib and the second outer rib.

In a further non-limiting embodiment of any of the foregoing traction battery packs, the thermal insulation medium is disposed between the inner rib and each of the first outer rib and the second outer rib.

In a further non-limiting embodiment of any of the foregoing traction battery packs, the flexible structure includes a flexible film layer that is connected to the structural barrier.

In a further non-limiting embodiment of any of the foregoing traction battery packs, the flexible film layer includes a thermoplastic material.

In a further non-limiting embodiment of any of the foregoing traction battery packs, the thermal insulation medium includes an aerogel, a polymer foam, a liquid, an air, or a low density solid.

In a further non-limiting embodiment of any of the foregoing traction battery packs, the flexible structure mechanically isolates a first portion of the structural barrier from a second portion of the structural barrier.

A traction battery pack according to another exemplary aspect of the present disclosure includes, among other things, a first grouping of battery cells, a second grouping of battery cells, and a thermal barrier assembly arranged between the first grouping of battery cells and the second grouping of battery cells. The thermal barrier assembly includes a structural barrier, a thermal insulation medium, and a flexible structure that contains the thermal insulation medium within an interior space of the structural barrier.

In a further non-limiting embodiment of the foregoing traction battery pack, the flexible structure includes a flexible link.

In a further non-limiting embodiment of either of the foregoing traction battery packs, the flexible link couples a first outer rib of the structural barrier to an upper plateau or a lower plateau of the structural barrier.

In a further non-limiting embodiment of any of the foregoing traction battery packs, the flexible structure includes a flexible film layer.

In a further non-limiting embodiment of any of the foregoing traction battery packs, the flexible structure completes an outer boundary for encapsulating the thermal insulation medium within the interior space.

In a further non-limiting embodiment of any of the foregoing traction battery packs, the flexible structure mechanically isolates a first portion of the structural barrier from a second portion of the structural barrier.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack of an electrified vehicle.

FIG. 3 is a cross-sectional view of select portions of a cell stack of a traction battery pack. The cell stack includes an exemplary thermal barrier assembly.

FIG. 4 illustrates another exemplary thermal barrier assembly.

FIG. 5 illustrates another exemplary thermal barrier assembly.

FIG. 6 illustrates another exemplary thermal barrier assembly.

FIG. 7 illustrates another exemplary thermal barrier assembly.

FIG. 8 illustrates yet another exemplary thermal barrier assembly.

### DETAILED DESCRIPTION

This disclosure details thermal barrier assemblies configured for inhibiting the transfer of thermal energy inside a traction battery pack while also simultaneously accommodating battery cell swelling forces and providing sufficient structural stiffness. An exemplary thermal barrier assembly may include a structural barrier, a thermal insulation medium, and one or more flexible structures that are arranged to contain the thermal insulation medium within an outer perimeter provided by the structural barrier. The flexible structures may be configured as flexible links or film layers that are capable of mechanically isolating a first portion of the structural barrier that contacts a battery cell undergoing swelling from a second portion of the structural barrier that is not in contact with the battery cell, thereby providing uniform resistance to the battery cell swelling forces while also providing structural stiffness. These and other features are discussed in greater detail in the following paragraphs of this detailed description.

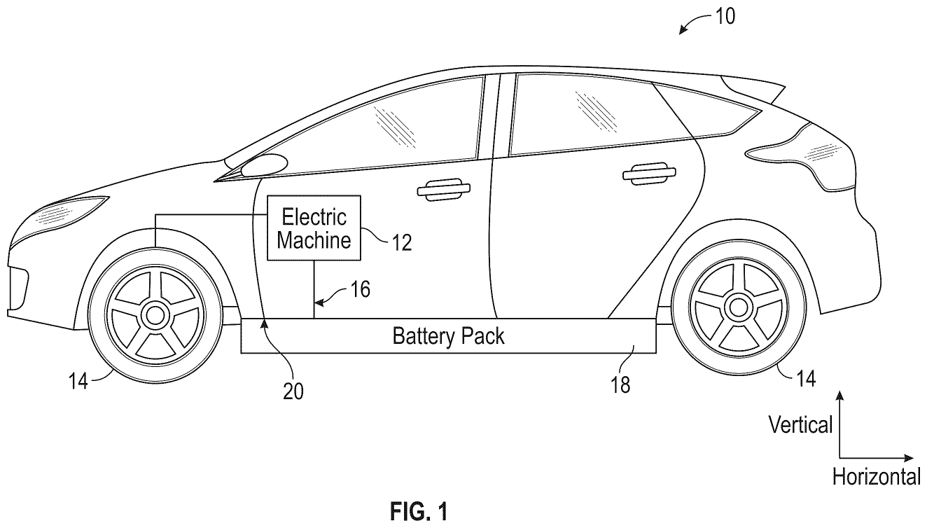

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

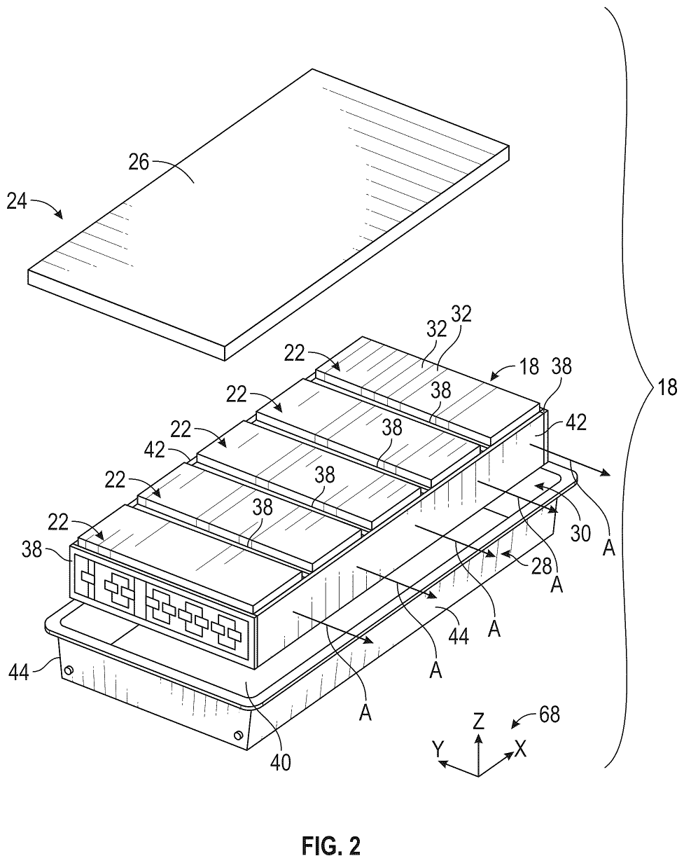

FIG. 2 illustrates additional details associated with the traction battery pack 18 of the electrified vehicle 10 of FIG. 1. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked together and arranged along a cell stack axis A. The battery cells 32 store and supply electrical power for powering various components of the electrified vehicle 10. Although a specific number of cell stacks 22 and battery cells 32 are illustrated in the various figures of this disclosure, the traction battery pack 18 could include any number of the cell stacks 22, with each cell stack 22 including any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The exemplary battery cells 32 can include tab terminals that project outwardly from a battery cell housing. The tab terminals of the battery cells 32 of each cell stack 22 are connected to one another, such as by one or more busbars, for example, in order to provide the voltage and power levels necessary for achieving electric vehicle propulsion.

The battery cells 32 of each cell stack 22 may be arranged between a pair of cross-member assemblies 38. Among other functions, the cross-member assemblies 38 may be configured to hold the battery cells 32 and at least partially delineate the cell stacks 22 from one another within the interior area 30 of the enclosure assembly 24.

Each cross-member assembly 38 may be configured to transfer a load applied to a side of the electrified vehicle 10, for example, for ensuring that the battery cells 32 do not become overcompressed. Each cross-member assembly 38 may be further configured to accommodate tension loads resulting from expansion and retraction of the battery cells 32. The cross-member assemblies 38 described herein are therefore configured to increase the structural integrity of the traction battery pack 18.

A vertically upper side of each cell stack 22 may interface with the enclosure cover 26, and a vertically lower side of each cell stack 22 may interface with a heat exchanger plate 40 that is positioned against a floor of the enclosure tray 28. In another embodiment, the heat exchanger plate 40 may be omitted and the vertically lower side of each cell stack 22 may be received in direct contact with the floor of the enclosure tray 28. Vertical and horizontal, for purposes of this disclosure, are with reference to ground and a general orientation of traction battery pack 18 when installed on the electrified vehicle 10 of FIG. 1.

The cross-member assemblies 38 may be adhesively secured to the enclosure cover 26 and to either the heat exchanger plate 40 or the enclosure tray 28 to seal the interfaces between these neighboring components and to structurally integrate the traction battery pack 18.

The traction battery pack 18 may additionally include a pair of structural plate members 42. One structural plate member 42 may be positioned between ends of the cell stacks 22 and each longitudinally extending side wall 44 of the enclosure tray 28, for example. The structural plate members 42 may extend along axes that are substantially transverse (e.g., perpendicular) to the cell stack axes A of the cell stacks 22 and to the cross-member assemblies 38. The structural plate members 42 can span across a majority of the length of the longitudinally extending side walls 44 of the enclosure tray 28 and are thus sometimes referred to as structural “megabars” of the traction battery pack 18. However, other configurations are contemplated within the scope of this disclosure.

The structural plate members 42 may be secured to the cell stacks 22 for further structurally integrating the traction battery pack 18. For example, a plurality of fasteners (e.g., bolts or screws, not shown) may be inserted through the structural plate members 42 and can be accommodated within fastener openings of the cross-member assemblies 38 for securing the structural plate members 42 directly to the cell stacks 22. These connections can help contain tensile loads that can occur over the life of the cell stacks 22 as a result of battery cell expansion forces, for example.

The traction battery pack 18 of FIG. 2 is shown relative to a three dimensional Cartesian coordinate system 68 that generally orients each cell stack 22 relative to X, Y, and Z axis directions. Axis line X generally represents an X-axis direction along a length of the traction battery pack 18, the axis line Y generally represents a Y-axis direction across a width of the traction battery pack 18, and the axis line Z generally represents a Z-axis direction along a height of the traction battery pack 18. Reference may be made periodically throughout this specification to the X-axis, the Y-axis, and the Z-axis directions. These directions coincide with the X, Y, and Z axes indicated by the Cartesian coordinate system 68 shown in FIG. 2.

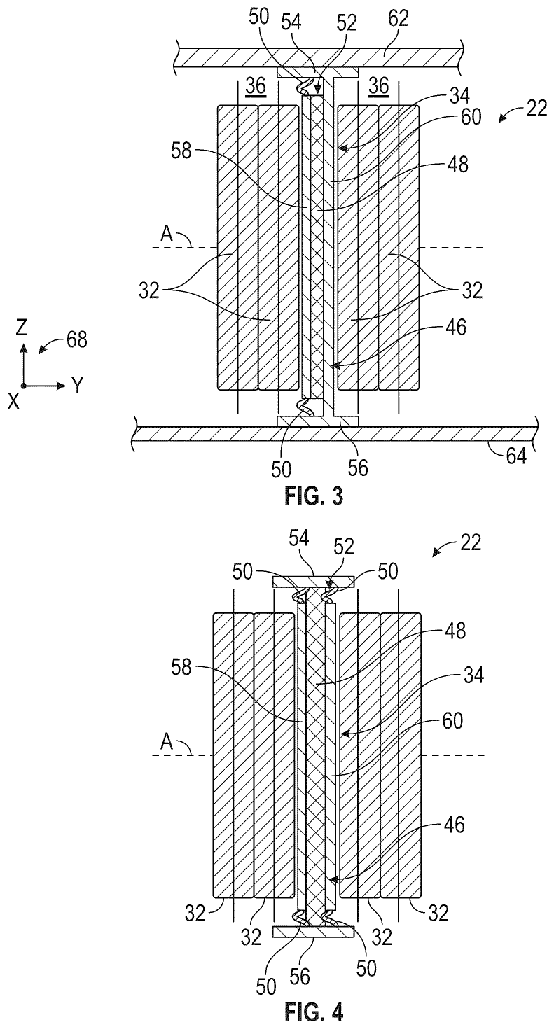

Referring now to FIGS. 3-6, with continued reference to FIGS. 1-2, one or more thermal barrier assemblies 34 may be arranged along the respective cell stack axis A of each cell stack 22. In this implementation, the cell stack axis A extends along the Y-axis of the Cartesian coordinate system 68

The thermal barrier assemblies 34 may compartmentalize each cell stack 22 into two or more groupings or compartments 36 of battery cells 32. Each compartment 36 may hold one or more of the battery cells 32 of the cell stack 22. Should, for example, a battery thermal event occur in one of the cell stacks 22, the thermal barrier assemblies 34 may reduce or even prevent thermal energy associated with the thermal event from moving from compartment-to-compartment, thereby inhibiting the transfer of thermal energy across the cell stack 22.

Each thermal barrier assembly 34 may include a structural barrier 46, a thermal insulation medium 48, and one or more flexible links 50. As further discussed below, the flexible links 50 may be configured to contain or encapsulate the thermal insulation medium 48 within an interior space 52 provided by the structural barrier 46.

The structural barrier 46 of the thermal barrier assembly 34 may act as a spacer for separating adjacent compartments 36 of the cell stack 22. The structural barrier 46 may include a thermoplastic structure or a polymer composite structure (e.g., glass fiber reinforced polypropylene with an intumescent additive), for example. However, other materials or combinations of materials could be utilized to construct the structural barrier 46 within the scope of this disclosure. The structural barrier 46 may additionally be an extruded part, an injection molded part, a pultruded part, etc.

The structural barrier 46 may include an upper plateau 54, a lower plateau 56, a first outer rib 58, and a second outer rib 60. The upper plateau 54 may be configured to interface with an upper enclosure structure 62 of the traction battery pack 18, and the lower plateau 56 may be configured to interface with a lower enclosure structure 64 of the traction battery pack 18 (see FIG. 3). The upper enclosure structure 62 may be part of the enclosure cover 26 of the enclosure assembly 24 or could be an intermediate structure (e.g., an actively cooled heat exchanger plate) that is positioned between the thermal barrier assembly 34 and the enclosure cover 26. The lower enclosure structure 64 may be part of the actively cooled heat exchanger plate 40 that is positioned between the thermal barrier assembly 34 and the enclosure tray 28, or could alternatively be part of the enclosure tray 28.

The upper enclosure structure 62 may be adhesively secured to the upper plateau 54, and the lower enclosure structure 64 may be adhesively secured to the lower plateau 56. Once the upper enclosure structure 62 and the lower enclosure structure 64 are each joined to the thermal barrier assembly 34, the upper and lower enclosure structures 62, 64 are effectively structurally coupled to one another. The thermal barrier assembly 34 is therefore configured for increasing the structural stiffness of the traction battery pack 18. Further, once joined to one or more perimeter structures of the traction battery pack 18, the thermal barrier assembly 34 can substantially prevent thermal energy from moving from one compartment 36 to another at the sealed interfaces between the thermal barrier assembly 34 and the perimeter structures (e.g., the upper enclosure structure 62 and the lower enclosure structure 64), such as during a battery thermal event, for example.

The upper plateau 54 and the lower plateau 56 may be disposed on opposite ends of the structural barrier 46, and the first outer rib 58 and the second outer rib 60 may extend vertically (along the Z-axis of the Cartesian coordinate system 68) between the upper plateau 54 and the lower plateau 56. When the thermal barrier assembly 34 is arranged within the cell stack 22, the first outer rib 58 may face toward and interface with one of the battery cells 32 of one compartment 36 of the cell stack 22, and the second outer rib 60 may face toward and interface with one of the battery cells 32 of an adjacent compartment 36 of the cell stack 22.

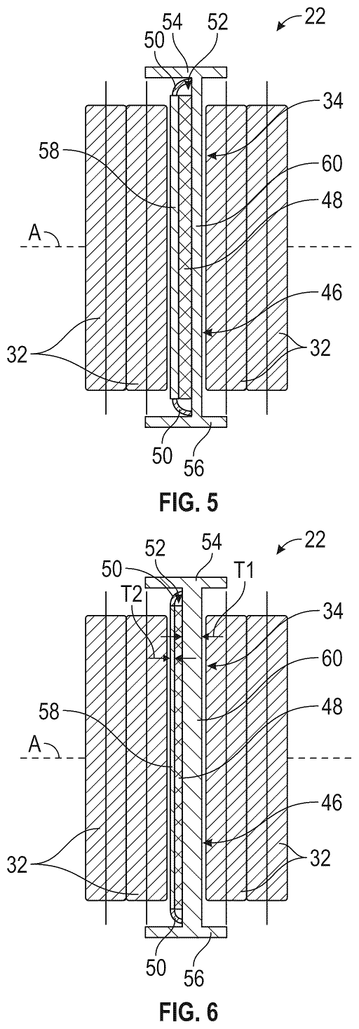

The first outer rib 58, the second outer rib 60, or both may be secured to other portions of the structural barrier 46 by the flexible links 50. In an embodiment, the first outer rib 58 (and/or the second outer rib 60) is connected to each of the upper plateau 54 and the lower plateau 56 of the structural barrier 46 by one of the flexible links 50 (see FIGS. 3 and 4). In another embodiment, the first outer rib 58 is connected to the second outer rib 60 of the structural barrier 46 by a pair of the flexible links 50 (see FIGS. 5 and 6).

The flexible links 50 may be made a polymeric material or an elastomeric material, for example. However, other materials that can provide some flexibility to the flexible links 50 are contemplated within the scope of this disclosure.

In an embodiment, each flexible link 50 includes a sinusoidal shaped cross-sectional profile (see FIGS. 3 and 4). In another embodiment, each flexible link 50 includes an arc shaped cross-sectional profile (see FIGS. 5 and 6). However, other cross-sectional profiles are contemplated within the scope of this disclosure.

The flexible links 50 are configured to be flexible in nature to allow the first outer rib 58 (and/or the second outer rib 60) to move relative to the remaining portions of the structural barrier 46 when a force acts thereon. The thermal barrier assembly 34 is therefore capable of providing a relatively uniform resistance to battery cell swelling forces that can occur along the Y-axis.

The flexible links 50 are further configured to mechanically isolate the first outer rib 58 and/or the second outer rib 60 from more rigid or non-flexible portions of the structural barrier 46. The thermal barrier assembly 34 is therefore capable of providing little if any resistances to loads acting along the Y-axis while simultaneously enhancing structural stiffness in both the X-axis and the Z-axis.

The flexible links 50 may be further configured to complete an outer boundary for containing the thermal insulation medium 48 within the interior space 52 of the structural barrier 46. The structural barrier 46 and the flexible links 50 may therefore cooperate together to establish an outer perimeter that substantially surrounds or encapsulates the thermal insulation medium 48 for containing the thermal insulation medium 48 within the interior space 52 of the structural barrier 46.

The thermal insulation medium 48 may include an aerogel, a polymer foam, a liquid, an air, a low density solid, etc. However, other types of thermally insulating mediums could be utilized within the scope of this disclosure.

In implementations in which the first outer rib 58 is joined to the structural barrier 46 by the flexible links 50 but the second outer rib 60 is not, the second outer rib 60 may include a thickness T1 that is greater than a thickness T2 of the first outer rib 58 along the Y-axis in order to provide a desired level of structural stiffness (see, e.g., the embodiment of FIG. 6). In other implementations, the first outer rib 58 and the second outer rib 60 may include equal thicknesses.

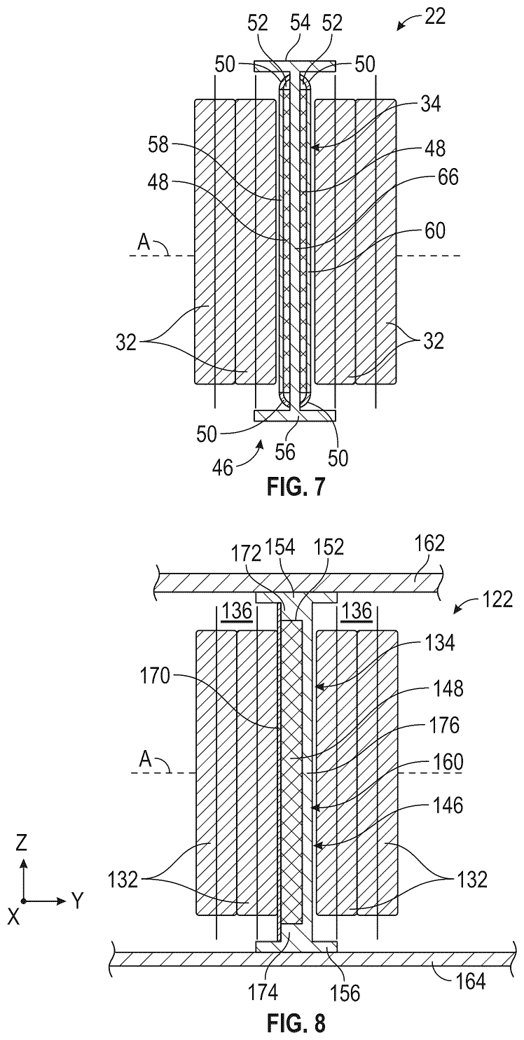

In another embodiment, shown in FIG. 7, the structural barrier 46 may additionally include an inner rib 66 located between the first outer rib 58 and the second outer rib 60. The thermal insulation medium 48 may be disposed between the inner rib 66 and each of the first outer rib 58 and the second outer rib 60. The inner rib 66 may function to structurally support the thermal insulation medium 48 and thereby prevent non-uniform compression.

FIG. 8 illustrates another exemplary thermal barrier assembly 134. The thermal barrier assembly 134 may include a structural barrier 146, a thermal insulation medium 148, and a flexible film layer 170. As further discussed below, the flexible film layer 170 may be configured to contain/encapsulate the thermal insulation medium 148 within an interior space 152 provided by the structural barrier 146.

The structural barrier 146 of the thermal barrier assembly 134 may act as a spacer for separating adjacent compartments 136 of a cell stack 122. Two or more battery cells 132 may be positioned with each compartment 136.

The structural barrier 146 may include a thermoplastic structure or a polymer composite structure (e.g., glass fiber reinforced polypropylene with an intumescent additive), for example. However, other materials or combinations of materials could be utilized to construct the structural barrier 146 within the scope of this disclosure. The structural barrier 146 may additionally be an extruded part, an injection molded part, a pultruded part, etc.

The structural barrier 146 may include an upper plateau 154, a lower plateau 156, and an outer rib 160. The upper plateau 154 may be configured to interface with an upper enclosure structure 162 of the traction battery pack 18, and the lower plateau 156 may be configured to interface with a lower enclosure structure 164 of the traction battery pack 18. The upper enclosure structure 162 may be part of the enclosure cover 26 of the enclosure assembly 24 or could be an intermediate structure (e.g., an actively cooled heat exchanger plate) that is positioned between the thermal barrier assembly 134 and the enclosure cover 26. The lower enclosure structure 164 may be part of the actively cooled heat exchanger plate 40 that is positioned between the thermal barrier assembly 134 and the enclosure tray 28, or could alternatively be part of the enclosure tray 28.

The upper enclosure structure 162 may be adhesively secured to the upper plateau 154, and the lower enclosure structure 164 may be adhesively secured to the lower plateau 156. Once the upper enclosure structure 162 and the lower enclosure structure 164 are each joined to the thermal barrier assembly 134, the upper and lower enclosure structures 162, 164 are effectively structurally coupled to one another. The thermal barrier assembly 134 is therefore configured for increasing the structural stiffness of the traction battery pack 18. Further, once joined to its perimeter structures, the thermal barrier assembly 134 can substantially prevent thermal energy from moving from one compartment 136 to another.

The upper plateau 154 and the lower plateau 156 may be disposed on opposite ends of the structural barrier 146, and the outer rib 160 may extend vertically (along the Z-axis) between the upper plateau 154 and the lower plateau 156. When the thermal barrier assembly 134 is arranged within the cell stack 122, the flexible film layer 170 may face toward and interface with one of the battery cells 132 of one compartment 136 of the cell stack 122, and the outer rib 160 may face toward and interface with one of the battery cells 132 of an adjacent compartment 136 of the cell stack 122.

The outer rib 160 may include an upper portion 172, a lower portion 174, and a mid-portion 176 that extends from the upper portion 172 to the lower portion 174. The upper portion 172 may be located adjacent to the upper plateau 154, and the lower portion 174 may be located adjacent to the lower plateau 156. In an embodiment, the upper plateau 154, the lower portion 174, and the outer rib 160 are formed together to provide a unitary structure of the structural barrier 146.

The flexible film layer 170 may be secured to portions of the structural barrier 146 to complete an outer boundary for containing the thermal insulation medium 148 within the interior space 152 of the structural barrier 146. The structural barrier 146 and the flexible film layer 170 may therefore cooperate together to establish an outer perimeter that surrounds the thermal insulation medium 148 for containing/encapsulating the thermal insulation medium 148 within the interior space 152 of the structural barrier 146. In an embodiment, the flexible film layer 170 is connected to both the upper portion 172 and the lower portion 174 of the outer rib 160 for containing the thermal insulation medium 148 within the interior space 152. However, other configurations are contemplated within the scope of this disclosure.

The flexible film layer 170 may be made of a suitable thermoplastic material. Suitable thermoplastic materials include but are not limited to polypropylene, high density polyethylene, polyethylene terephthalate (PET), plastic laminates, and acrylic based materials. However, the actual material make-up of the flexible film layer 170 is not intended to limit this disclosure.

The flexible film layer 170 is configured to be flexible of conformable in nature and can thus move relative to the outer rib 160 of the structural barrier 146 when a force acts thereon. The thermal barrier assembly 134 is therefore capable of providing a relatively uniform resistance to battery cell swelling forces that can occur along the cell stack axis A. Further, the flexible film layer 170 is mechanically isolated from the outer rib 160, thereby allowing the outer rib 160 to transmit loads acting along either the X-axis or the Z-axis of the cell stack 122.

The thermal insulation medium 148 may be an aerogel, a polymer foam, a liquid, an air, a low density solid, etc. However, other materials or combinations of materials could be utilized to construct the thermal insulation medium 48 within the scope of this disclosure.

The thermal barrier assemblies of this disclosure incorporated both flexible and non-flexible structures. The thermal barrier assemblies are therefore uniquely designed to mitigate the transfer of thermal energy, enhance structural stiffness, and accommodate battery cell swelling within a single structure.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a thermal barrier assembly arranged to partition a battery cell stack into a first compartment and a second compartment; and
the thermal barrier assembly including a structural barrier, a thermal insulation medium, and a flexible structure that contains the thermal insulation medium within an interior space of the structural barrier.

2. The traction battery pack as recited in claim 1, wherein the flexible structure includes a first flexible link that secures a first outer rib of the structural barrier to a first portion of the structural barrier, and a second flexible link that secures the first outer rib to a second portion of the structural barrier.

3. The traction battery pack as recited in claim 2, wherein the first portion is an upper plateau of the structural barrier, and the second portion is a lower plateau of the structural barrier.

4. The traction battery pack as recited in claim 3, wherein the upper plateau interfaces with an upper enclosure structure of the traction battery pack, and the lower plateau interfaces with a lower enclosure structure of the traction battery pack.

5. The traction battery pack as recited in claim 2, wherein the first portion and the second portion are each part of a second outer rib of the structural barrier.

6. The traction battery pack as recited in claim 2, wherein the first flexible link and the second flexible link each include a sinusoidal shaped cross-sectional profile or an arc shaped cross-sectional profile.

7. The traction battery pack as recited in claim 2, wherein the flexible structure includes a third flexible link that secures a second outer rib of the structural barrier to the first portion of the structural barrier, and a fourth flexible link that secures the second outer rib to the second portion of the structural barrier.

8. The traction battery pack as recited in claim 7, wherein the second outer rib includes a first thickness that is greater than a second thickness of the first outer rib.

9. The traction battery pack as recited in claim 7, wherein the structural barrier includes an inner rib arranged between the first outer rib and the second outer rib.

10. The traction battery pack as recited in claim 9, wherein the thermal insulation medium is disposed between the inner rib and each of the first outer rib and the second outer rib.

11. The traction battery pack as recited in claim 1, wherein the flexible structure includes a flexible film layer that is connected to the structural barrier.

12. The traction battery pack as recited in claim 11, wherein the flexible film layer is comprised of a thermoplastic material.

13. The traction battery pack as recited in claim 1, wherein the thermal insulation medium includes an aerogel, a polymer foam, a liquid, an air, or a low density solid.

14. The traction battery pack as recited in claim 1, wherein the flexible structure mechanically isolates a first portion of the structural barrier from a second portion of the structural barrier.

15. A traction battery pack, comprising:
a first grouping of battery cells;
a second grouping of battery cells; and
a thermal barrier assembly arranged between the first grouping of battery cells and the second grouping of battery cells and including a structural barrier, a thermal insulation medium, and a flexible structure that contains the thermal insulation medium within an interior space of the structural barrier.

16. The traction battery pack as recited in claim 15, wherein the flexible structure includes a flexible link.

17. The traction battery pack as recited in claim 16, wherein the flexible link couples a first outer rib of the structural barrier to an upper plateau or a lower plateau of the structural barrier.

18. The traction battery pack as recited in claim 15, wherein the flexible structure includes a flexible film layer.

19. The traction battery pack as recited in claim 15, wherein the flexible structure completes an outer boundary for encapsulating the thermal insulation medium within the interior space.

20. The traction battery pack as recited in claim 15, wherein the flexible structure mechanically isolates a first portion of the structural barrier from a second portion of the structural barrier.
